(19) United States
(12) Patent Application Publication
(10) Pub. No.: US 2014/0302272 A1
(43) Pub. Date: Oct. 9, 2014

(54) BALLISTIC RESISTANT ARTICLE COMPRISING POLYETHYLENE TAPES

(71) Applicant: TEIJIN ARAMID B.V., Amhen (NL)

(72) Inventors: Anton Peter De Weijer, Nijmegen (NL); Sanjay Rastogi, Eindhoven (NL); Soon Joo Bovenschen, Arnhem (NL); Joris Van De Eem, Arnhem (NL); Johannes Adrianus Roos, Doetinchem (NL)

(21) Appl. No.: 14/356,711

(22) PCT Filed: Nov. 6, 2012
(86) PCT No.: PCT/EP2012/071938

§ 371 Date: May 7, 2014

(30) Foreign Application Priority Data
Nov. 7, 2011 (EP) 11188069.6

(51) Int. Cl. F41H 5/04; B32B 7/00

(52) U.S. Cl. CPC F41H 5/04; B32B 7/005
USPC 428/107; 428/337; 264/258

(57) ABSTRACT

A ballistic-resistant moulded article containing a compressed stack of sheets that contain high molecular weight polyethylene tapes. The direction of the polyethylene tapes within the compressed stack is not unidirectional. At least part of the tapes have a width of at least 2 mm, a thickness to width ratio of at least 10:1, and a density of at most 99% of the theoretical tape density. The moulded article is made of tapes that have a density below the theoretical density of the tapes.

The present invention pertains to ballistic resistant articles comprising polyethylene tapes, and to a method for manufacturing thereof.

EP 833 742 describes a ballistic resistant moulded article containing a compressed stack of monolayers, with each monolayer containing unidirectionally oriented fibres and at most 30 wt. % of an organic matrix material. This publication indicates that the density of the compressed stack should be at least 98% of the theoretical maximum density. In this publication this is obtained by subjecting the stack of monolayers to a pressure of at least 13 MPa (130 bar).

While this material shows adequate properties, there is still a need for alternative materials manufactured though a less intensive process. There is also need for materials with improved ballistic properties.

It has now been found this problem can be solved by the use of polyethylene tapes with specific properties.

The present invention pertains to a ballistic-resistant moulded article comprising a compressed stack of sheets comprising high molecular weight polyethylene tapes, the direction of the polyethylene tapes within the compressed stack being not unidirectionally, wherein at least part of the tapes have a width of at least 2 mm and a thickness to width ratio of at least 10:1 and a density of at most 99% of the theoretical tape density.

The theoretical tape density is the density of the polymeric component of the tape. It is governed by the crystallinity of the polyethylene, and can be calculated as follows. The crystallinity of the polymeric component is determined using, e.g., XRD, NMR, or DSC. The theoretical tape density is defined as the amorphous fraction (which is 1—the crystalline fraction), multiplied by the density of amorphous polyethylene which is set at 0.892 g/ml plus the crystalline fraction multiplied by the density of crystalline polyethylene, which is set at 0.998g/cm³ (derived from the orthorhombic unit cell structure, which is the predominant constituent of the crystalline polyethylene (G. T. Davis, R. K. Eby, G. M. Martin; J.Appl.Phys. 39, 4973, (1968))).

The actual tape density is defined as the weight of the tape in grams divided by its geometrical volume in cm³. The actual tape density in a compressed stack is determined as follows; The individual tapes in a compressed stack are separated from the stack and the matrix material is removed by a suitable solvent. Suitable in this context means that the solvent is a non-solvent for polyethylene. The density of the tapes is measured as described above after solvent has been completely removed.

The actual tape density of the tapes as present in the compressed stack of sheets in the moulded article according to the invention is at most 99% of the theoretical tape density. This means that the tapes contain a substantial volume of a low-density component, e.g., air. Not wishing to be bound by theory, it is believed that the fact that the tapes contain air somehow contributes to the energy dissipation of the panel upon impact of a projectile, and therefore results in a ballistic material with good ballistic properties. In one embodiment, the actual tape density of the tapes as present in the compressed stack at most 98% of the theoretical tape density, in particular at most 97%, in some embodiments at most 96%. The actual tape density of the tapes as present in the compressed stack may be even lower, depending on tape properties and compression conditions. In one embodiment, the actual tape density of the tapes as present in the compressed stack is at most 92% of the theoretical tape density, in particular at most 90%, in some embodiments at most 85%. The actual tape density of the tapes in the compressed stack generally is at least 60% of the theoretical tape density, in particular at least 70%.

It is noted that US2009/0243138 describes a process for the production of UHMWPE tapes by the steps of compacting UHMWPE powder to form a sheet, and stretching the sheet. The reference indicates that the product of the compaction process is a “virtually full dense and translucent UHMWPE sheet, with a density of about 0.95 to about 0.98 g/cc. No information is provided on the density of the stretched tapes. While it is indicated that the tapes may be used in ballistic panels, it is not described how this should be effected, and no information on the density of the tapes as present in the final panel can be derived therefrom.

US2008/0251960 describes a tape manufacturing process. Again, the reference mentions the general use of the tapes produced therein in ballistic materials. However, no information on the density of the tapes as present in the final panel can be derived therefrom. The same goes for WO2010/090627 and US2006/0210749.

The compressed stack of sheets in the ballistic material of the present invention has a density which is well below the theoretical density of the compressed stack. The theoretical density of the compressed stack is defined as follows:
ρ(th-st)=ρ(th-tapes) * m(tapes)+ρ(matrix) * m(matrix) ρ(th-st) is the theoretical density of the compressed stack; ρ(th-tapes) is the theoretical tape density described above; m(tapes) is the mass fraction of the tapes in the compressed stack;
ρ(matrix) is the theoretical matrix density, that is the density of the polymer matrix as it is in the stack after compression, i.e., upon removal of any volatile components and solvents.

In one embodiment, the density of the compressed stack of sheets in the ballistic material of the present invention is at most 97% of the theoretical density of the compressed stack, more in particular at most 96% still more in particular at most 95%. The density of the compressed stack may be even lower, depending on tape properties and compression conditions. In one embodiment, the density of the compressed stack is at most 92% of the theoretical compressed stack density, in particular at most 90%, in some embodiments at most 85%. In general the density of the compressed stack of sheets will be at least 60% of the theoretical stack density, in particular at least 70%.

The present invention also pertains to a method for manufacturing a ballistic-resistant moulded article, which comprising the steps of providing sheets comprising polyethylene starting tapes, stacking the sheets in such a manner that the direction of the starting tapes within the compressed stack is not unidirectionally, and compressing the stack, wherein at least part of the starting tapes have a width of at least 2 mm and a thickness to width ratio of at least 10:1, at least part of the starting tapes having a density of at most 99% of the theoretical tape density.

Depending on the manufacturing process, the density of the tapes in the final compressed stack may be higher than the density of the starting tapes, or may be the same as the density of the starting tapes. In other words, depending on the manufacturing process, the starting tapes may be compressed during the process, resulting in tapes with higher density. On the other hand, depending on the manufacturing process, and on the density of the starting tapes, the starting tapes may be not influenced during the process, resulting in tapes with the same density.

Parameters which influence the tape density in the final product include the starting density of the tape, the pressure conditions applied during manufacture of the panel, with higher pressure leading to a higher density, the temperature conditions applied during manufacture of the panel, with higher temperature leading to a higher density, and the compression time, with a longer compression time leading to a higher density. Taking the above generally applicable guidelines into account it is within the scope of the skilled person to control the process conditions in such a manner that products with the desired tape density are obtained.

In one embodiment, the actual tape density of the starting tapes is at most 98% of the theoretical tape density, in particular at most 95% of the theoretical density, in particular at most 92% of the theoretical density, and sometimes at most 90%. In some embodiments, tape densities may be lower, e.g., at most 85% of the theoretical tape density, and sometimes at most 80%.

In general the actual tape density will be at least 50% of the theoretical tape density, in particular at least 60%. More specifically, the tape density may be at least 70%. These values apply both for the density of the tapes in the compressed stack, and for the density of the starting tapes.

It has been found that the selection of tapes with a width and a width to thickness ratio in the claimed range with the specified density leads to a ballistic material with attractive properties. More in particular, this combined selection of properties leads to a ballistic material which combines good ballistic performance with attractive manufacturing conditions. The use of tapes with the specified low density leads to panels with a ballistic performance which is as good as, or even better than the ballistic performance of panels based on higher density tapes.

The tape used in the present invention is an object of which the length is larger than the width and the thickness, while the width is in turn larger than the thickness. In the tapes used in the present invention, the ratio between the width and the thickness is more than 10:1, in particular more than 20:1, more in particular more than 50:1, still more in particular more than 100:1. The maximum ratio between the width and the thickness is not critical to the present invention. It generally is at most 1000:1, depending on the tape width. The width of the tape used in the present invention is at least 2 mm, in particular at least 10 mm, more in particular at least 20 mm. The use of wider tapes may be preferred for reasons of both manufacturing and product properties. Accordingly, in one embodiment, the tapes have a with of at least 40 mm, or even at least 60 mm. The maximum value for he width of the tape is not critical. A value of 400 mm may be mentioned. The thickness of the tape is generally at least 8 microns, in particular at least 10 microns. The thickness of the tape is generally at most 150 microns, more in particular at most 100 microns.

For application of the tapes in ballistic-resistant moulded articles it is essential that the tapes bodies are ballistically effective, which, more specifically, requires that they have a high tensile strength, a high tensile modulus and a high energy absorption, reflected in a high energy-to-break. It is preferred for the tapes have a tensile strength of at least 1.0 GPa, a tensile modulus of at least 40 GPa, and a tensile energy-to-break of at least 15 J/g.

In one embodiment, the tensile strength is at least 1.2 GPa, more in particular at least 1.5 GPa, still more in particular at least 1.8 GPa, even more in particular at least 2.0 GPa, still more in particular at least 2.5 GPa, more in particular at least 3.0 GPa, still more in particular at least 4.0 GPa. Tensile strength is determined in accordance with ASTM D7744.

In another embodiment, the tensile modulus is at least 50 GPa. The modulus is determined in accordance with ASTM D7744. More in particular, the tensile modulus is at least 80 GPa, more in particular at least 100 GPa, still more in particular at least 120 GPa, even more in particular at least 140 GPa, or at least 150 GPa.

In another embodiment, the tensile energy to break is at least 20 J/g, in particular at least 25 J/g, more in particular at least 30 J/g, even more in particular at least 35 J/g, still more in particular at least 40 J/g, or at least 50 J/g. The tensile energy to break is determined in accordance with ASTM D7744 using a strain rate of 50%/min. It is calculated by integrating the energy per unit mass under the stress-strain curve.

In the present invention use is made of polyethylene tapes. It is preferred for the tapes used in the present invention sheet to be high-drawn tapes of high-molecular weight linear polyethylene. High molecular weight here means a weight average molecular weight of at least 400 000 g/mol. Linear polyethylene here means polyethylene having fewer than 1 side chain per 100 C atoms, preferably fewer than 1 side chain per 300 C atoms.

In one embodiment the polyethylene is a homopolymer of ethylene or a copolymer of ethylene with a co-monomer which is another alpha-olefin or a cyclic olefin, both with generally between 3 and 20 carbon atoms. Examples include propene, 1-butene, 1-pentene, 1-hexene, 1-heptene, 1-octene, cyclohexene, etc. The use of dienes with up to 20 carbon atoms is also possible, e.g., butadiene or 1-4 hexadiene. The amount of non-ethylene alpha-olefin in the ethylene homopolymer or copolymer used in the process according to the invention preferably is at most 10 mole %, preferably at most 5 mole %, more preferably at most 1 mole %. If a non-ethylene alpha-olefin is used, it is generally present in an amount of at least 0.001 mol. %, in particular at least 0.01 mole %, still more in particular at least 0.1 mole %. The use of a material which is substantially free from non-ethylene alpha-olefin is preferred. Within the context of the present specification, the wording substantially free from non-ethylene alpha-olefin is intended to mean that the only amount non-ethylene alpha-olefin present in the polymer are those the presence of which cannot reasonably be avoided.

It is particularly preferred to use tapes of ultra-high molecular weight polyethylene (UHMWPE), that is, polyethylene with a weight average molecular weight (Mw) of at least 500 000 g/mol. The use of tapes with a Mw of at least 1*10⁶ gram/mol, in particular at least 2*10⁶ gram/mol, may be particularly preferred. The maximum Mw of the UHMWPE tapes suitable for use in the present invention is not critical. As a general value a maximum value of 1*10⁸ g/mol may be mentioned. The molecular weight distribution and molecular weigh averages (Mw, Mn, Mz) may be determined as described in WO2009/109632.

It has been found that tapes for use in the present invention are preferably based on polyethylene which has a relatively low content of low-molecular weight components. In one embodiment, the polyethylene has a content of material with a molecular weight of below 400 000 gram/mole of at most 20 wt. %, in particular at most 10 wt. %, more in particular at most 5 wt. %. In one embodiment, the polyethylene has a content of material with a molecular weight of below 100 000 gram/mole of at most 8 wt. %, in particular at most 5 wt. %, more in particular at most 2 wt. %. The use of ultra-high molecular weight with these properties is believed to contribute to the ballistic performance of the panel. This may be because of the properties of the material itself, and/or because the suitability of the material for the manufacture of low-density tapes.

Within the present specification, the term sheet refers to an individual sheet comprising tapes, which sheet can individually be combined with other, corresponding sheets. The sheet may or may not comprise a matrix material. The term “matrix material” means a material which binds the tapes and/or the sheets together. The compressed stack may or may not comprise a matrix material.

It is considered preferred at this point in time for the compressed stack to contain a matrix material. It was found that the presence of a matrix material in the compressed stack contributes to the ballistic performance of the panel, in particular as regards resistance to delamination and multi-hit trauma.

In the case that a matrix material is used in the compressed stack, the matrix material is present in the compressed stack in an amount of 0.2-40 wt. %, calculated on the total of tapes and organic matrix material. The use of more than 40 wt. % of matrix material was found not to further increase the properties of the ballistic material, while only increasing the weight of the ballistic material. Where present, it may be preferred for the matrix material to be present in an amount of at least 1 wt. %, more in particular in an amount of at least 2 wt. %, in some instances at least 2.5 wt. %. Where present, it may be preferred for the matrix material to be present in a amount of at most 30 wt. %, sometimes at most 25 wt. %.

In one embodiment of the present invention, a relatively low amount of matrix material is used, namely an amount in the range of 0.2-8 wt. %. In this embodiment it may be preferred for the matrix material to be present in an amount of at least 1 wt. %, more in particular in an amount of at least 2 wt. %, in some instances at least 2.5 wt. %. In this embodiment it may be preferred for the matrix material to be present in a amount of at most 7 wt. %, sometimes at most 6.5 wt. %.

The matrix material may be present in the individual sheet, between the sheets, or both in the sheets and between the sheets. When matrix material is present in the sheet itself, it may wholly or partially encapsulate the tapes in the sheet. It may also be present between tapes in a sheet, e.g., where the sheet comprises overlapping tapes.

In one embodiment of the present invention, matrix material is provided on the sheet, to adhere the sheet to further sheets within the stack.

The present invention also pertains to sheets suitable for use in the manufacture of a ballistic-resistant moulded article comprises tapes adhered to each other, at least part of the tapes having a width of at least 2 mm and a thickness to width ratio of at least 10:1 and a density of at most 99% of the theoretical tape density, in particular at most 98%. For further information on the tape density reference is made to what has been stated earlier for the starting tapes. Preferably, the tapes in the sheet are arranged in parallel. In one embodiment, the sheet comprises overlapping tapes arranged in parallel, wherein the tapes are connected at the point of overlap, by compression or by using a matrix, preferably by using a matrix.

The invention also pertains to a crossply comprising a first sheet and a second sheet as described above, the second sheet being bonded on top of the first sheet, wherein the direction of the tapes in the first sheet is rotated with respect to the direction of the tapes in the second monolayer. Preferably, the rotation is over an angle of at least 45°. It is preferred for the rotation to be over about 90°. Preferably first monolayer and the second monolayer are bonded through a matrix material. In one embodiment a matrix layer is also present on the top of the bottom of the crossply to allow easier bonding to further crossplies or further sheets. The invention also pertains to crossplies comprising further sheets in addition to the first and second sheet, e.g., crossplies comprising 4, 6, or 8 sheets.

The matrix may be provided in the solid state, e.g., in the form of a film, strip, or web, or in the liquid state, e.g., in the form of a melt or a dispersion or solution. The use of a liquid material, in particular a solution or dispersion may be preferred. The matrix material may be deposited homogenous or inhomogeneous over the sheets, in the sheets, or throughout the stack.

The provision of a matrix material is well known in the art. For further information reference is made to WO2009/109632, the relevant disclosure of which is incorporated herein by reference. The organic matrix material, if used, may wholly or partially consist of a polymer material, which optionally may contain fillers usually employed for polymers. The polymer may be a thermoset or thermoplastic or mixtures of both. Preferably a soft plastic is used, in particular it is preferred for the organic matrix material to be an elastomer with a tensile modulus (at 25° C.) of at most 41 MPa. The use of non-polymeric organic matrix material is also envisaged. The purpose of the matrix material is to help to adhere the tapes and/or the sheets together where required, and any matrix material which attains this purpose is suitable as matrix material.

Preferably, the elongation to break of the organic matrix material is higher than the elongation to break of the reinforcing tapes. The elongation to break of the matrix preferably is from 3 to 500%. These values apply to the matrix material as it is in the final ballistic-resistant article.

Thermosets and thermoplastics that are suitable for the sheet are listed in for instance EP833742 and WO-A-91/12136. Preferably, vinylesters, unsaturated polyesters, epoxides or phenol resins are chosen as matrix material from the group of thermosetting polymers. These thermosets usually are in the sheet in partially set condition (the so-called B stage) before the stack of sheets is cured during compression of the ballistic-resistant moulded article. From the group of thermoplastic polymers polyurethanes, polyvinyls, polyacrylates, polyolefins or thermoplastic, elastomeric block copolymers such as polyisoprene-polyethylenebutylene-polystyrene or polystyrene-polyisoprenepolystyrene block copolymers are preferably chosen as matrix material.

In one embodiment the compressed sheet stack of the present invention meets the requirements of class II of the NIJ Standard—0101.04 P-BFS performance test. In a preferred embodiment, the requirements of class IIIa of said Standard are met, in an even more preferred embodiment, the requirements of class III are met, or the requirements of even higher classes. This ballistic performance is preferably accompanied by a low areal weight, in particular for NIJIII an areal weight of at most 19 kg/m2, more in particular at most 16 kg/m2. In some embodiments, the areal weight of the stack may be as low as 15 kg/m2, or even as low as at most 13 kg/m2. The minimum areal weight of the stack is given by the minimum ballistic resistance required.

In one embodiment the ballistic-resistant material according to the invention preferably has a peel strength of at least 5N, more in particular at least 5.5 N, determined in accordance with ASTM-D 1876-00, except that a head speed of 100 mm/minute is used.

Depending on the final use and on the thickness of the individual sheets, the number of sheets in the stack in the ballistic resistant article according to the invention is generally at least 2, in particular at least 4, more in particular at least 8. The number of sheets is generally at most 500, in particular at most 400.

In the present invention the direction of tapes within the compressed stack is not unidirectionally. This means that in the stack as a whole, tapes are oriented in different directions. In one embodiment of the present invention the tapes in a sheet are unidirectionally oriented, and the direction of the tapes in a sheet is rotated with respect to the direction of the tapes of other sheets in the stack, more in particular with respect to the direction of the tapes in adjacent sheets. Good results are achieved when the total rotation within the stack amounts to at least 45 degrees. Preferably, the total rotation within the stack amounts to approximately 90 degrees. In one embodiment of the present invention, the stack comprises adjacent sheets wherein the direction of the tapes in one sheet is substantially perpendicular to the direction of tapes in adjacent sheets.

In one embodiment, the stack comprises sheets which consist of a layer of tapes aligned in a partially overlapping arrangement, e.g., in the form of a bricklayered arrangement as described in WO 2008/040506. In this embodiment a sheet comprises a first layer of parallel tapes with at least one further layer of tapes provided onto the first layer parallel and offset to the tapes in the first layer. The tapes in the further layer(s) are adhered to the tapes in the first layer to form a sheet with structural integrity consisting of parallel tapes. This adhering can be carried out through a heat-pressing step. It is considered preferred, however, to ensure adherence through the use of a matrix material, where no heat-pressing step is required. The thus-obtained sheets comprising parallel tapes can then be stacked in such a manner that the tape direction in the sheets differ from the tape direction in an adjacent sheet. In a preferred embodiment, the sheets are stacked in such a manner that the tape direction in a first sheet differs from the tape direction in the second sheet by approximately 90° . Preferably, a matrix is also present between the individual sheets thus prepared.

A ballistic panel may be manufactured from the sheets as described above by subjecting the stack as described above to a compression step. As has been explained above, a key feature of the present invention is that the polyethylene tapes have a density which is below the theoretical polymer density, and this is believed to contribute to the ballistic performance of the panel. It is therefore not the intention to compress the panel in such a manner that all air is removed from the panel. Thus, in one embodiment, the compression is carried out in such a manner that the density of the compressed stack of sheets in the ballistic material of the present invention is at most 97% of the theoretical density of the compressed stack, more in particular at most 96%, still more in particular at most 95%. In one embodiment, the density of the compressed stack is at most 92% of the theoretical compressed stack density, in particular at most 90%, in some embodiments at most 85%. It is within the scope of the skilled person to select the compression conditions to be such that this value is obtained.

In one embodiment, the compression is carried out in such a manner that the pressure used is below 100 bar, in particular below 80 bar. It has been found that substantially lower pressures may also be used, e.g., a pressure of below 60 bar, below 50 bar, or below 40 bar. In one embodiment, the pressure will generally be at least 5 bar, in particular at least 10 bar.

In one embodiment, the compression step is carried out by bringing the stack under vacuum. This can be done by bringing the stack into, e.g., a flexible bag, after which the air is removed from the bag to obtain a reduced pressure in the bag. The compression then takes place by atmospheric pressure. The advantage of this embodiment is that it allows the application of a homogenous pressure on all surfaces of the stack, which is believed to make for homogeneous compression. The pressure difference is relatively small in this embodiment, less than 1 atmosphere, and this allows the manufacture of low-density panels.

In another embodiment, the compression step is carried out using isostatic means, which means that the compression at all parts of the panel is homogeneous.

In another embodiment, a conventional plate press is used.

Where necessary, the temperature during compression is selected such that the matrix material is brought above its softening or melting point, if this is necessary to cause the matrix to help adhere the tapes and/or sheets to each other. Compression at an elevated temperature is intended to mean that the moulded article is subjected to the given pressure for a particular compression time at a compression temperature above the softening or melting point of the organic matrix material and below the softening or melting point of the tapes.

The required compression time and compression temperature depend on the nature of the tape and matrix material and on the thickness of the moulded article and can be readily determined by the person skilled in the art.

Where the compression is carried out at elevated temperature, it may be preferred for the cooling of the compressed material to also take place under pressure. Cooling under pressure is intended to mean that the given minimum pressure is maintained during cooling at least until so low a temperature is reached that the structure of the moulded article can no longer relax under atmospheric pressure. It is within the scope of the skilled person to determine this temperature on a case by case basis. Where applicable it is preferred for cooling at the given minimum pressure to be down to a temperature at which the organic matrix material has largely or completely hardened or crystallized and below the relaxation temperature of the reinforcing tapes. The pressure during the cooling does not need to be equal to the pressure at the high temperature. During cooling, the pressure should be monitored so that appropriate pressure values are maintained, to compensate for decrease in pressure caused by shrinking of the moulded article and the press.

Depending on the nature of the matrix material, for the manufacture of a ballistic-resistant moulded article according to the invention, in which the reinforcing tapes are high-drawn tapes of high-molecular weight linear polyethylene, the compression temperature is preferably 115 to 135° C. and cooling to below 70° C. is effected at a constant pressure. Within the present specification the temperature of the material, e.g., compression temperature refers to the temperature at half the thickness of the moulded article.

In the process of the invention the stack may be made starting from individual loose sheets. Loose sheets are difficult to handle, however, in that they easily tear in the direction of the tapes. It is therefore preferred to make the stack from consolidated sheet packages containing from 2 to 8, as a rule 2, 4 or 8. For the orientation of the sheets within the sheet packages, reference is made to what has been stated above for the orientation of the sheets within the compressed stack.

Consolidated is intended to mean that the sheets are firmly attacked to one another. The sheets may be consolidated by the application of heat and/or pressure, as is known in the art, or using a matrix material, as is also known in the art. This latter option may be preferred.

In one embodiment of the present invention, polyethylene tapes are used with a high molecular orientation as is evidenced by their XRD diffraction pattern.

In one embodiment of the present invention, the tapes have a 200/110 uniplanar orientation parameter Φ of at least 3. The 200/110 uniplanar orientation parameter Φ is defined as the ratio between the 200 and the 110 peak areas in the X-ray diffraction (XRD) pattern of the tape sample as determined in reflection geometry.

Wide angle X-ray scattering (WAXS) is a technique that provides information on the crystalline structure of matter. The technique specifically refers to the analysis of Bragg peaks scattered at wide angles. Bragg peaks result from long-range structural order. A WAXS measurement produces a diffraction pattern, i.e. intensity as function of the diffraction angle 2θ (this is the angle between the diffracted beam and the primary beam). The 200/110 uniplanar orientation parameter gives information about the extent of orientation of the 200 and 110 crystal planes with respect to the tape surface. For a tape sample with a high 200/110 uniplanar orientation the 200 crystal planes are highly oriented parallel to the tape surface. It has been found that a high uniplanar orientation is generally accompanied by a high tensile strength and high tensile energy to break. The ratio between the 200 and 110 peak areas for a specimen with randomly oriented crystallites is around 0.4. However, in the tapes that are preferentially used in one embodiment of the present invention the crystallites with indices 200 are preferentially oriented parallel to the film surface, resulting in a higher value of the 200/110 peak area ratio and therefore in a higher value of the uniplanar orientation parameter. The value for the 200/110 uniplanar orientation parameter may be determined using an X-ray diffractometer as described in WO2009/109632. The UHMWPE tapes with narrow molecular weight distribution used in one embodiment of the ballistic material according to the invention have a 200/110 uniplanar orientation parameter of at least 3. It may be preferred for this value to be at least 4, more in particular at least 5, or at least 7. Higher values, such as values of at least 10 or even at least 15 may be particularly preferred. The theoretical maximum value for this parameter is infinite if the peak area 110 equals zero. High values for the 200/110 uniplanar orientation parameter are often accompanied by high values for the strength and the energy to break.

In one embodiment of the present invention, the UHMWPE tapes have a DSC crystallinity of at least 74%, more in particular at least 80%. The DSC crystallinity can be determined as follows using differential scanning calorimetry (DSC), for example on a Perkin Elmer DSC7. Thus, a sample of known weight (2 mg) is heated from 30 to 180° C. at 10° C. per minute, held at 180° C. for 5 minutes, then cooled at 10° C. per minute. The results of the DSC scan may be plotted as a graph of heat flow (mW or mJ/s; y-axis) against temperature (x-axis). The crystallinity is measured using the data from the heating portion of the scan. An enthalpy of fusion ΔH (in J/g) for the crystalline melt transition is calculated by determining the area under the graph from the temperature determined just below the start of the main melt transition (endotherm) to the temperature just above the point where fusion is observed to be completed. The calculated ΔH is then compared to the theoretical enthalpy of fusion (ΔH_{c} of 293 J/g) determined for 100% crystalline PE at a melt temperature of approximately 140° C. A DSC crystallinity index is expressed as the percentage 100(ΔH/ΔH_{c}). In one embodiment, the tapes used in the present invention have a DSC crystallinity of at least 85%, more in particular at least 90%.

In general, the polyethylene tapes used in the present invention have a polymer solvent content of less than 0.05 wt. %, in particular less than 0.025 wt. %, more in particular less than 0.01 wt. %.

The tapes used in the present invention may have a high strength in combination with a high linear density. In the present application the linear density is expressed in dtex. This is the weight in grams of 10.000 metres of film. In one embodiment, the film according to the invention has a denier of at least 3000 dtex, in particular at least 5000 dtex, more in particular at least 10000 dtex, even more in particular at least 15000 dtex, or even at least 20000 dtex, in combination with strengths of, as specified above, at least 2.0 GPa, in particular at least 2.5 GPA, more in particular at least 3.0 GPa, still more in particular at least 3.5 GPa, and even more in particular at least 4 GPa.

In one embodiment of the present invention, the polyethylene tapes are tapes manufactured by a process which comprises subjecting a starting polyethylene with a weight average molecular weight of at least 100 000 gram/mole to a compacting step and a stretching step under such conditions that at no point during the processing of the polymer its temperature is raised to a value above its melting point. For further information on the polyethylene properties reference is made to what is stated elsewhere in this document on the polymer properties.

This process, which is in its basic embodiment known in the art, is also indicated as solid state processing, to indicate the difference with processes where the polyethylene is subjected to a melting step.

It has been found that tapes with a low density can be manufactured through this process, in particular by ensuring that the process is accompanied by high tensile forces during drawing. This can be done, in al., by one or more of the following measures: selection of a relatively low stretching temperature, selection of a relatively high deformation speed, and selection of a relatively high stretching ratio. As indicated earlier, polyethylene with a relatively low fraction of low molecular weight component is particularly suitable for the manufacture of tapes with a low density. With the indications above and the process description further on, it is within the scope of the skilled person to manufacture low-density tapes.

In one embodiment, the starting material for the tape manufacturing process is a highly disentangled UHMWPE.

In this case, the starting polymer has an elastic shear modulus G_{N}⁰ determined directly after melting at 160° C. of at most 1.4 MPa, more in particular at most 1.0 MPa, still more in particular at most 0.9 MPa, even more in particular at most 0.8 MPa, and even more in particular at most 0.7. The wording “directly after melting” means that the elastic modulus is determined as soon as the polymer has melted, in particular within 15 seconds after the polymer has melted. For this polymer melt, the elastic modulus typically increases from 0.6 to 2.0 MPa in several hours. The elastic shear modulus directly after melting at 160° C. is a measure for the degree of entangledness of the polymer. G_{N}⁰ is the elastic shear modulus in the rubbery plateau region. It is related to the average molecular weight between entanglements Me, which in turn is inversely proportional to the entanglement density. In a thermodynamically stable melt having a homogeneous distribution of entanglements, Me can be calculated from G_{N}⁰ via the formula G_{N}⁰=g_{N}ρRT/Mₑ, where g_{N} is a numerical factor set at 1, rho is the density in g/cm3, R is the gas constant and T is the absolute temperature in K. A low elastic modulus thus stands for long stretches of polymer between entanglements, and thus for a low degree of entanglement. The adopted method for the investigation on changes in with the entanglements formation is the same as described in publications (Rastogi, S., Lippits, D., Peters, G., Graf, R., Yefeng, Y. and Spiess, H., “Heterogeneity in Polymer Melts from Melting of Polymer Crystals”, Nature Materials, 4(8), 1 Aug. 2005, 635-641 and PhD thesis Lippits, D. R., “Controlling the melting kinetics of polymers; a route to a new melt state”, Eindhoven University of Technology, dated 6 Mar. 2007, ISBN 978-90-386-0895-2).

In one embodiment, the polyethylene used in the manufacture of the tapes used in the ballistic material according to the invention has a strain hardening slope of below 0.10 N/mm at 135° C. Preferably, it also has a strain hardening slope of below 0.12 N/mm at 125° C. The strain hardening slope is determined by subjecting compressed polymer to a drawing step under specific conditions.

The test is carried out as follows: polymer powder is subjected to compaction at a pressure of 200 bar, at 130° C., for 30 minutes to form tensile bars with a thickness of 1 mm, a width of 5 mm and a length of 15 mm. The bars are subjected to drawing at a tensile speed of 100 mm/min at a temperature of 125° C. or 135° C.

The drawing temperature is chosen such that no melting of the polymer occurs, as can be checked by DSC in simple heating mode. The bar is drawn from 10 mm to 400 mm. For the tensile test a force cell of 100N is used. The force cell measures force required for the elongation of the sample at the fixed temperature. The force/elongation curve shows a first maximum, which is also known as the yield point. The strain hardening slope is defined as the steepest positive slope in the force/elongation curve after the yield point.

In one embodiment of the present invention, the polymer has a strain hardening slope, determined at 135 ° C., of below 0.10 N/mm, in particular below 0.06 N/mm, more in particular below 0.03 N/mm. In another embodiment, the polymer has a strain hardening slope, determined at 125 ° C., of below 0.12 N/mm, in particular below 0.08 N/mm, more in particular below 0.03 N/mm. In a preferred embodiment, the polymer meets the stipulated requirements both at 125 ° C. and at 135 ° C.

A low strain hardening slope means that the material has high drawability at low stress. While not wishing to be bound by theory, it is believed that this means in turn that the polymer chains in the solid states contain few entanglements, and that this will enable the manufacture of tapes and fibers with good properties in accordance with the present invention. In other words, a strain hardening slope within this range means that there is little entanglement between the polymer chains. In the present specification, a polyethylene with a strain hardening slope as specified above will therefore also be indicated as a disentangled polyethylene.

In one embodiment of the present invention, an ultra-high molecular weight polyethylene is used as starting material for the tape manufacturing process which can be compressed below its equilibrium melting temperature of 142° C., more in particular within the temperature range of 100-138° C., wherein the thus-obtained film can be drawn below the equilibrium meting temperature by more than 15 times its initial length.

The disentangled UHMWPE that may be used in the manufacture of tapes for use in the present invention may have a bulk density which is significantly lower than the bulk density of conventional UWMWPEs. More in particular, the UHMWPE used in the process according to the invention may have a bulk density below 0.25 g/cm³, in particular below 0.18 g/cm³, still more in particular below 0.13 g/cm³. The bulk density may be determined in accordance with ASTM-D1895. A fair approximation of this value can be obtained as follows. A sample of UHMWPE powder is poured into a measuring beaker of exact 100 ml. After scraping away the surplus of material, the weight of the content of the beaker is determined and the bulk density is calculated.

In the process for manufacturing low-density polyethylene tapes for use in the present invention the polymer is provided in particulate form, for example in the form of a powder, or in any other suitable particulate form. Suitable particles have a particle size of up to 5000 micron, preferably up to 2000 micron, more in particular up to 1000 micron. The particles preferably have a particle size of at least 1 micron, more in particular at least 10 micron. The particle size distribution may be determined by laser diffraction (PSD, Sympatec Quixel or Malvern) as follows. The sample is dispersed into surfactant-containing water and treated ultrasonic for 30 seconds to remove agglomerates/ entanglements. The sample is pumped through a laser beam and the scattered light is detected. The amount of light diffraction is a measure for the particle size.

The compacting step is carried out to integrate the polymer particles into a single object, e.g., in the form of a mother sheet. The stretching step is carried out to provide orientation to the polymer and manufacture the final product. The two steps are carried out at a direction perpendicular to each other. It is noted that it is within the scope of the present invention to combine these elements in a single step, or to carry out the process in different steps, each step performing one or more of the compacting and stretching elements. For example, in one embodiment of the process according to the invention, the process comprises the steps of compacting the polymer powder to form a mothersheet, rolling the plate to form rolled mothersheet and subjecting the rolled mothersheet to a stretching step to form a polymer film.

The compacting force applied in the process according to the invention generally is 10-10000 N/cm², in particular 50-5000 N/cm2, more in particular 100-2000 N/cm². The density of the material after compacting is generally between 0.7 and 1.0 g/cm³.

In the process according to the invention the compacting and rolling step is generally carried out at a temperature of at least 1° C. below the unconstrained melting point of the polymer, in particular at least 3° C. below the unconstrained melting point of the polymer, still more in particular at least 5° C. below the unconstrained melting point of the polymer. Generally, the compacting step is carried out at a temperature of at most 40° C. below the unconstrained melting point of the polymer, in particular at most 30° C. below the unconstrained melting point of the polymer, more in particular at most 10° C.

In the process according to the invention the stretching step is generally carried out at a temperature of at least 1° C. below the melting point of the polymer under process conditions, in particular at least 3° C. below the melting point of the polymer under process conditions, still more in particular at least 5° C. below the melting point of the polymer under process conditions. As the skilled person is aware, the melting point of polymers may depend upon the constraint under which they are put. This means that the melting temperature under process conditions may vary from case to case. It can easily be determined as the temperature at which the stress tension in the process drops sharply. Generally, the stretching step is carried out at a temperature of at most 30° C. below the melting point of the polymer under process conditions, in particular at most 20° C. below the melting point of the polymer under process conditions, more in particular at most 15° C.

In one embodiment of the present invention, the stretching step encompasses at least two individual stretching steps, wherein the first stretching step is carried out at a lower temperature than the second, and optionally further, stretching steps. In one embodiment, the stretching step encompasses at least two individual stretching steps wherein each further stretching step is carried out at a temperature which is higher than the temperature of the preceding stretching step.

As will be evident to the skilled person, this method can be carried out in such a manner that individual steps may be identified, e.g., in the form of the films being fed over individual hot plates of a specified temperature. The method can also be carried out in a continuous manner, wherein the film is subjected to a lower temperature in the beginning of the stretching process and to a higher temperature at the end of the stretching process, with a temperature gradient being applied in between. This embodiment can for example be carried out by leading the film over a hot plate which is equipped with temperature zones, wherein the zone at the end of the hot plate nearest to the compaction apparatus has a lower temperature than the zone at the end of the hot plate furthest from the compaction apparatus.

In one embodiment, the difference between the lowest temperature applied during the stretching step and the highest temperature applied during the stretching step is at least 3° C., in particular at least 7° C., more in particular at least 10° C. In general, the difference between the lowest temperature applied during the stretching step and the highest temperature applied during the stretching step is at most 30° C., in particular at most 25° C. The total stretching ratio applied in the one, two, three, or more stretching steps may bat at least 80, or at least 100. In one embodiment the total stretching ratio may be at least 120, in particular at least 140, more in particular at least 160. The total stretching ratio is defined as the area of the cross-section of the compacted mothersheet divided by the cross-section of the final film produced from this mothersheet.

The present invention will be elucidated by the following Example, without being limited thereto or thereby.

### EXAMPLE 1

The starting materials were tapes of ultra-high molecular weight polyethylene (UHMWPE) with a width of around 132,8 mm and a thickness of 55±5 μm. The tapes had a tensile strength of 2,3 ±0,2 GPa, a tensile modulus of 165±15 GPa, and a density of 0.850 g/cm³.

Sheets were manufactured by aligning tapes in parallel to form a first layer, providing a matrix material onto one surface of the layer of tapes, aligning a at least one further layer of tapes onto the first layer parallel and offset to the tapes in the first layer, with the matrix being present between the two tape layers. A further matrix layer is present on the top of the layer.

Sets of sheets were cross-plied to form stacks. The stacks had a matrix content of 2.7%. The stacks were compressed at a temperature of 136-137° C., at different pressures. The density of the tapes in the stacks was determined. The ballistic performance of the panels is tested using the 9 mm parabellum full metal jacket (FMJ) soft core bullet (DM41), this ammunition has a standard firing velocity of 425 m/s. The panels are fixed on a Weible plasticine backing using torque strappings, and positioned 10 meters form the barrel. The performance is evaluated via a standard V50 value estimation protocol.

The properties and results are presented in table 1 below.

TABLE 1

| | | Relative tape | |
|---|---|---|---|
| | | density in | |
| | Pressure | panel | SEA |
| Example | (bar) | [ ] | [Jm²/kg] |
| 1 | 10 | 0.864 | 205 |
| 2 | 35 | 0.929 | 207 |
| 4 | 55 | 0.948 | 209 |
| 4 | 94 | 0.957 | 206 |

The results in Table 1 show that high SEA values are obtained with relative tape densities in the claimed range. The results also show that the pressure applied during manufacture of the panel influences the density of the tapes in the final product.

1. A ballistic-resistant moulded article comprising a compressed stack of sheets comprising high molecular weight polyethylene tapes, wherein:
the direction of the polyethylene tapes within the compressed stack is not unidirectional, and
at least part of the tapes have a width of at least 2 mm, a thickness to width ratio of at least 10:110:1, and a density of at most 99% of a theoretical tape density.

2. The ballistic-resistant moulded article according to claim 1, wherein the compressed stack of sheets has a density that is at most 97% of a theoretical density of the compressed stack.

3. A sheet of a the ballistic-resistant moulded article according to claim 1, the sheet comprising tapes adhered to each other, wherein at least part of the tapes have a width of at least 2 mm, a thickness to width ratio of at least 10:1 and a density of at most 99% of the theoretical tape density.

4. The sheet according to claim 3, wherein the tapes are arranged in parallel.

5. The sheet according to claim 4, further comprising overlapping tapes arranged in parallel, wherein the tapes are connected at the point of overlap, by compression or by using a matrix.

6. A crossply comprising sheets according to claim 4, the sheets comprising a first sheet and a second sheet, wherein:
the second sheet is bonded on top of the first sheet; and
the direction of the tapes in the first sheet is rotated with respect to the direction of the tapes in the second sheet.

7. A crossply according to claim 6, wherein the first sheet and the second sheet are bonded through a matrix material.

8. A method for manufacturing a ballistic-resistant moulded article, the method comprising;
providing sheets comprising polyethylene starting tapes,
stacking the sheets so that the direction of the starting tapes within the stack is not unidirectional, and
compressing the stack,
wherein at least part of the starting tapes have a width of at least 2 mm, a thickness to width ratio of at least 10:1, and a density of at most 99% of a theoretical tape density.

9. A method according to claim 8, wherein the stack is compressed using a pressure used below 100 bar.
